(19) United States
(12) Patent Application Publication
(10) Pub. No.: US 2024/0275101 A1
(43) Pub. Date: Aug. 15, 2024

(54) FLAT SOCKET CONTACT DEVICE

(71) Applicant: TE Connectivity Solutions GmbH, Schaffhausen (CH)

(72) Inventors: Kevin SCHEER, Bensheim (DE); Harald ULRICH, Bensheim (DE); Willi DIETRICH, Bensheim (DE); Daniel ROSAN, Bensheim (DE)

(21) Appl. No.: 18/438,879

(22) Filed: Feb. 12, 2024

(30) Foreign Application Priority Data
Feb. 15, 2023 (DE) 102023103680.7

(51) Int. Cl. H01R 13/187; H01R 13/193

(52) U.S. Cl. CPC H01R 13/187; H01R 13/193

(57) ABSTRACT

An electrical flat socket contact device for an electrical power connection includes a carrier structure, wherein the carrier structure forms a primarily cuboid contact box unit, into which a primarily cuboid tab contact for electrically contacting the flat socket contact device can be plugged; and a primarily cuboid contact body arranged in the contact box unit for contacting the tab contact plugged into the contact box unit, wherein the contact body is arranged on a base wall of the carrier structure, wherein on a top wall of the carrier structure arranged opposite the base wall there is arranged at least one spring element unit for mechanically contacting the tab contact, and wherein the top wall has at least twice the wall thickness of the base wall.

### CROSS REFERENCE TO RELATED APPLICATIONS

This application claims the benefit of DE Application No. 102023103680.7 filed 15 Feb. 2023, the subject matter of which is herein incorporated by reference in its entirety.

### BACKGROUND OF THE INVENTION

The subject matter herein relates to a flat socket contact device, in particular for use in automotive engineering.

Flat socket contact devices for electrical power connections, in particular in automotive engineering, are known from the prior art. The flat socket contact device can be used in particular for an electrical battery module in a vehicle that can be electrically powered. The flat socket contact device is suitable for use in the high-current range.

A need remains for an improved flat socket contact device for an electrical high-current connection.

### BRIEF DESCRIPTION OF THE INVENTION

In one embodiment, an electrical flat socket contact device for an electrical power connection is provided including a carrier structure and a primarily cuboid contact body. The carrier structure forms a primarily cuboid contact box unit, into which a primarily cuboid tab contact for electrically contacting the flat socket contact device can be plugged. The primarily cuboid contact body is arranged in the contact box unit for contacting the tab contact plugged into the contact box unit. The contact body is arranged on a base wall of the carrier structure, wherein on a top wall of the carrier structure arranged opposite the base wall there is arranged at least one spring element unit for mechanically contacting the tab contact. The top wall has a greater wall thickness than the base wall.

This can achieve the technical advantage that an improved electrical flat socket contact device can be provided for an electrical high-current connection. For this purpose, the flat socket contact device comprises a carrier structure which forms a primarily cuboid contact box unit into which a primarily cuboid tab contact can be plugged to create the high-current connection. A primarily cuboid contact body for contacting the tab contact is arranged in the contact box unit. On a top wall, the contact body, there is arranged at least one spring element unit, by means of which the contacting of the plugged tab contact can be effected. The top wall of the carrier structure has a greater wall thickness here than the base wall of the carrier structure. Due to the greater wall thickness, a higher contact normal force of the spring element unit can be achieved, whereby the tab contact plugged into the contact box unit can be pressed against the contact body with an increased contact pressure. This can improve the electrical contact between the tab contact and the contact body. In particular, the restoring forces of the spring element unit can be used to generate contact normal forces in the region of 60 newtons. Depending on the application, spring element units with higher restoring forces can also be used, which enable higher contact normal forces if this is required. The high contact normal forces exerted by the spring element unit on the tab contact can be used to press the tab contact more firmly against the contact body. This enables an efficient electrical connection to be made between the self-plugged tab contact and the contact body, which is suitable for a high-current connection. The high contact normal forces that can be provided by the spring element unit also ensure greater vibration resistance of the electrical connection between the tab contact and the contact body. The flat socket contact device fulfils the requirements of HV vibration classes >2+ or class 3.

The base wall and the top wall are formed by the two largest surfaces of the cuboid carrier structure or the contact box unit and are arranged opposite each other. The carrier structure or contact box unit defines a primarily cuboid receiving space.

According to one embodiment, the top wall comprises an inner partial wall and an outer partial wall, wherein the inner and outer partial walls are arranged to contact one another in a planar manner, wherein the inner partial wall defines an inner wall of the contact box unit, and wherein the at least one spring element unit is formed on the inner partial wall.

The technical advantage of this is that the top wall can be generated with twice the wall thickness using two partial walls arranged in planar contact with each other. The inner partial wall, which defines an inner wall of the contact box unit, comprises the spring element unit that extends into the interior of the contact box unit. The outer partial wall resting on the inner partial wall, on the other hand, does not comprise a spring element unit and is primarily used to stiffen the inner partial wall in order to enable the contact normal force of the spring element unit to be increased. The outer partial wall resting on the inner partial wall thus enables a technically simple stiffening of the entire carrier structure and thus an increase in the possible contact normal force of the spring element unit, which can exert an increased contact normal force on the tab contact and thus enables improved electrical contacting of the inserted tab contact. In particular, the wall thickness of the top wall can be at least twice the wall thickness of the base wall.

According to one embodiment, the base wall is integrally connected to the inner partial wall via a first side wall element and via a second side wall element, wherein the first and second wall elements define side walls of the contact box unit.

This has the technical advantage that a robust carrier structure can be provided by the integral connection of the base wall to the inner partial wall via a first side wall element and to the outer partial wall via a second side wall element, each of which defines side walls of the contact box unit. In this case, the two side wall elements delimit the primarily cuboid receiving space of the contact box unit.

According to one embodiment, the carrier structure is designed as a multi-surface bending structure.

This has the technical advantage that the multi-surface bending structure makes it easy to manufacture the carrier structure.

According to one embodiment, the first and second side wall elements are each arranged at an angle to the base wall and to the inner and outer partial walls via 90° bends.

In this way, the technical advantage can be achieved that the 90° bends of the first and second side wall elements relative to the base wall and the inner and outer partial walls enable a simple and robust design of the carrier structure. The 90° bends describe an angular range between 75° and 105°, preferably between 80° and 100°, even more preferably between 85° and 95°, and particularly preferably 90°.

According to one embodiment, the at least one spring element unit is formed integrally on the inner partial wall.

This has the technical advantage that the integral design of the spring element unit on the inner partial wall enables a robust design of the spring element unit and a robust connection of the spring element unit to the carrier structure.

According to one embodiment, the at least one spring element unit is designed as a bending element and is arranged on a side edge of the inner partial wall, wherein the spring element unit extends at least partially along the inner partial wall over a 180° bend.

This has the technical advantage that the design of the spring element unit as a bending element, which is formed integrally on the inner partial wall, enables a robust spring element unit. In addition, the spring element unit is easy to manufacture within the contact box unit thanks to the 180° bend, which allows the spring element unit to be aligned partially parallel to the inner partial wall. The 180° bends describe an angular range between 165° and 195°, preferably between 170° and 190°, even more preferably between 175° and 185°, and particularly preferably 180º.

According to one embodiment, the inner partial wall and the outer partial wall are connected to each other via at least one clinch connection and/or a welded connection.

The technical advantage of this is that the clinch connection and/or the welded connection enable the inner and outer partial walls to be securely and robustly fixed together.

According to one embodiment, a fixing catch is arranged on the outer partial wall and/or on the base wall for fixing the flat socket contact device to a holding device.

This can achieve the technical advantage that the flat socket contact device can be securely arranged on a mounting device, for example in a vehicle, thanks to the fixing catches on the outer partial wall and/or the base wall. The fixing catches allow the flat socket contact device to be mounted easily.

According to one embodiment, a plurality of contacting domes and/or spring element units are formed on the contact body for contacting the tab contact.

This can achieve the technical advantage that the contacting domes and/or the contacting springs of the contact body enable efficient and powerful contacting with the contact, which allows high-current conduction.

According to one embodiment, the contact body is fixed to the base wall of the carrier structure within the contact box unit via at least one clinch connection.

This has the technical advantage that the contact body is securely fixed in the contact box unit by the clinch connections. The clinch connections are a simple solution here for fixing the contact body.

Within the meaning of the application, a clinch connection can also be designed as a locking tab connection.

According to one embodiment, the at least one clinch connection is formed at a front end, via which the tab contact can be inserted into the contact box unit, and/or at a rear end of the contact box unit arranged opposite the front end.

This has the technical advantage that the clinch connection at the front end prevents the contact body from slipping out of the contact box unit via the insertion opening. The clinch connections at the rear end of the contact box unit, on the other hand, can prevent the contact body from tilting relative to the contact box unit. The clinch connections at the rear end are arranged on a side region of the contact body.

The front end of the contact box unit is defined by the insertion opening of the contact box unit.

According to one embodiment, the contact body comprises at least one receiving recess at a front end and/or on a side region of the contact body for receiving the at least one clinch connection.

This has the technical advantage that the clinch connections can engage securely in the contact body through the recesses at the front end or side region of the contact body, so that the contact body can be prevented from shifting or tilting within the contact box unit.

According to one embodiment, the contact box unit is limited at the rear end by a rear wall of the carrier structure.

This has the technical advantage that the rear wall arranged at the rear end of the contact box unit prevents the tab contact from slipping through the contact box unit. The tab contact can therefore be precisely positioned in the contact box unit by the rear wall.

According to an embodiment, the rear wall is formed in one piece on a side edge of the inner partial wall, wherein the rear wall is arranged at an angle to the inner partial wall via a 90° bend.

This has the technical advantage that the rear wall is secured to the carrier structure thanks to the one-piece design of the rear wall on the inner partial wall. The 90° bend of the rear wall relative to the inner partial wall enables a simple technical solution for aligning the rear wall relative to the contact box unit.

According to one embodiment, the carrier structure is made of stainless steel or a copper compound.

This has the technical advantage that a stable and robust carrier structure can be provided.

According to one embodiment, the carrier structure is configured via the at least one spring element unit to provide a contact normal force of up to 40 N, preferably 50 N, particularly preferably 60 N, for contacting the inserted tab contact.

This has the technical advantage that, via the increased restoring force of the spring element unit, an increased contact normal force can be exerted on the tab contact to be contacted. This enables high-performance electrical contacting of the tab contact with the contact body, which enables high-current use in the high-current range. In addition, the high contact normal forces can be used to improve the vibration resistance of the connection. The contact normal force is oriented perpendicular to the surface of the tab contact.

According to one embodiment, the tab contact can be clamped in the contact box unit via the spring element unit.

This has the technical advantage that, via the increased restoring force of the spring element unit and the contact normal force exerted on the tab contact, the tab contact can be securely fixed in the contact box unit. Slipping of the tab contact out of the contact box unit and the associated interruption of the electrical contact can therefore be avoided.

According to one embodiment, the flat socket contact device is designed for electrical voltages of at least approximately: 200V, 300V, 400V, 500V, 1 kV, 1.25 kV or 1.5 kV and/or for electrical currents of at least approximately: 200 A, 300 A, 400 A, 500 A, 600 A, 800 A, 1 kA or 1.25 kV.

This has the technical advantage that the flat socket contact device can be used for a wide range of electrical voltages and electrical currents, particularly in the high-voltage or high-current range.

According to one aspect, an electrical connection system with an electrical flat socket contact device according to one of the preceding embodiments and a primarily cuboid tab contact is provided.

### BRIEF DESCRIPTION OF THE DRAWINGS

The invention is explained in greater detail below with reference to the figures. In the figures:

FIG. 1 shows a schematic representation of an electrical connection system according to one embodiment,

FIG. 2 shows a schematic representation of an electrical flat socket contact device according to one embodiment,

FIG. 3 shows a further schematic representation of an electrical flat socket contact device according to a further embodiment,

FIG. 4 shows a further schematic representation of an electrical flat socket contact device according to a further embodiment,

FIG. 5 shows a further schematic representation of an electrical flat socket contact device according to a further embodiment,

FIG. 6 shows a further schematic representation of an electrical flat socket contact device according to a further embodiment,

FIG. 7 shows a further schematic representation of an electrical flat socket contact device according to a further embodiment, and

FIG. 8 shows a further schematic representation of an electrical flat socket contact device according to a further embodiment.

### DETAILED DESCRIPTION OF THE INVENTION

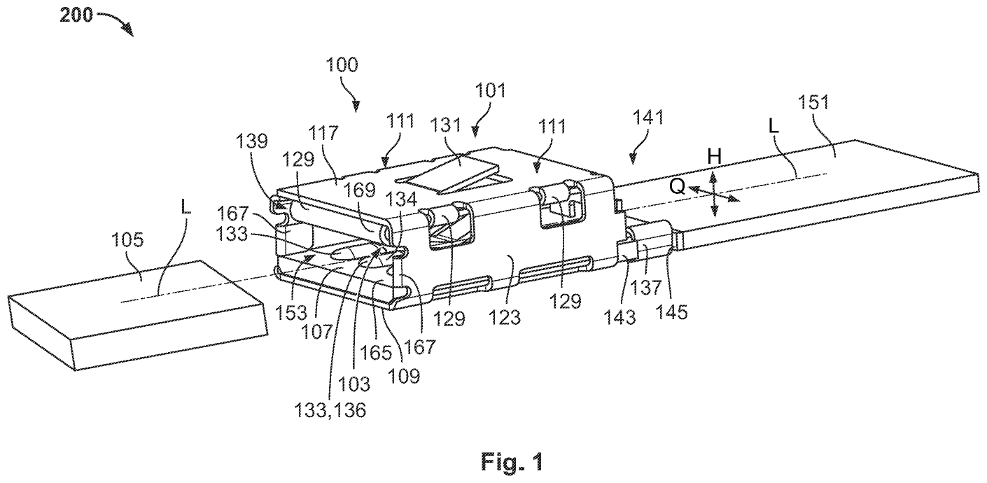

FIG. 1 shows a schematic representation of an electrical connection system 200 according to one embodiment.

The electrical connection system 200 shown comprises an electrical flat socket contact device 100 and a primarily cuboid tab contact 105.

The electrical flat socket contact device 100 comprises a carrier structure 101. The carrier structure 101 defines a primarily cuboid contact box unit 103. The tab contact 105 can be inserted into the contact box unit 103 along a longitudinal direction L of the carrier structure 101 via an opening 153 of the carrier structure 101. The carrier structure 101 comprises a base wall 109, a top wall 111 arranged opposite the base wall 109, and two side wall elements 121, 123 connecting the base wall 109 and the top wall 111 to one another. The first and second side wall elements 115, 117 are designed to be spaced apart parallel to one another along the transverse direction Q.

A primarily cuboid contact body 107 is arranged in the primarily cuboid contact box unit 103. The contact body 107 rests on the base wall 109 of the carrier structure. The top wall 111 and the base wall 109 are defined by the two large surfaces of the cuboid contact box unit 103 and are arranged parallel to each other and spaced apart along a height direction H of the contact box unit 103.

In an exemplary embodiment, the top wall 111 has a greater wall thickness than the base wall 109. Preferably, the wall thickness of the top wall 111 is at least twice as great as the wall thickness of the base wall 109. Furthermore, at least one spring element unit 113, not visible in FIG. 1, is arranged on the top wall 111. The spring element unit 113 extends into the contact box unit 103 and serves to make contact with the tab contact 105 inserted into the contact box unit 103. A contact normal force can be exerted, via the spring element unit 113, on the tab contact 105 inserted into the contact box unit 103. The tab contact 105 is pressed against the contact body 107 via the contact normal force, as a result of which the electrical contact is made between the tab contact 105 and the contact body 107. In the embodiment shown, the spring element unit 113 is connected to the top wall 111, in particular to the inner partial wall 115, via a 180° bend. The 180° bend is formed at the front end 139 on the inner partial wall 115 and the spring element unit 113 thus runs parallel to the longitudinal axis L of the contact box unit 103.

The contact body 107 is also connected to a line connection element 151 for the electrical current connection. The line connection element 151 is arranged outside the contact box unit 103 defined by the carrier structure 101 and is used for the electrical connection. The line connection element 151 can, for example, be designed as a cable lug, by means of which the flat socket contact device 100 can be connected to a cable. The contact body 107 can be made of a copper alloy, for example. Alternatively or additionally, the line connection element 151 can be designed as a crimping, ultrasonic or welding pad.

In the embodiment shown, the inserted tab contact 105 is arranged between the contact body 107 arranged in the contact box unit 103 and the top wall 111 of the carrier structure 101.

In the embodiment shown, the contact body 107 has a plurality of contacting domes 133 for electrical contacting. The contacting domes 133 are formed on a surface 165 of the contact body 107 and protrude from this surface 165 into the contact box unit 103. The inserted tab contact 105 is thus pressed onto the contact body 107 via the contact pressure of the spring element unit 113, whereby point contacting of the tab contact 105 with the plurality of contacting domes 133 is effected. In the embodiment shown, the contacting domes 133 each comprise a partially cylindrical shape with an at least partially circular outer surface 134 and an at least partially spherical end region 136. The contacting domes 133 have at least partially cylindrical shapes and comprise at least partially circular outer surfaces 134, which protrude from the surface 165. The surface 165 is formed by one of the two large surfaces of the cuboid contact body 107 and is oriented parallel to the inner partial wall 115.

In the embodiment shown, the contact body 107 is connected to the carrier structure 101 via clinch connections 137. The clinch connections 137 are connected here integrally to the carrier structure 101 and, in the embodiment shown, engage in receiving recesses 145 formed on a side region 143 of the contact body 107. The side region 143 is formed by at least one of the small surfaces of the cuboid contact body 107, which rest against the two side wall elements 121, 123. In the embodiment shown, the clinch connections 137 are formed in a rear end 141 of the carrier structure 101. The rear end 141 is arranged here opposite a front end 139 of the carrier structure 101.

In the embodiment shown, the top wall 111 comprises an outer partial wall 117 and an inner partial wall, not visible in FIG. 1. The inner and outer partial walls 115, 117 are arranged here to lie flat on top of each other.

In the embodiment shown, the outer partial wall 117, which defines an outer boundary of the carrier structure 101, has a fixing catch 131. The fixing catch 131 serves to fix the flat socket contact device 100 in a receiving structure, for example in a vehicle. The flat socket contact device 100 can be fixed securely in a corresponding holding structure for holding contact devices via the fixing catch 131.

In the embodiment shown, the first and second side wall elements 121, 123 each have, at the end face 139, two fold-over elements 167 bent in the direction of the receiving chamber 103. In this case, the fold-over elements 167 have a 180° bend and are arranged at least partially parallel to the first and second wall elements 121, 123.

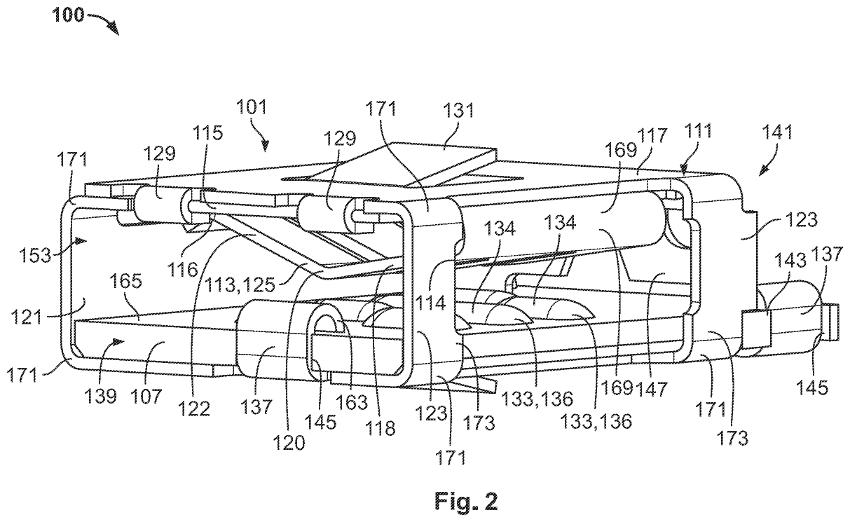

FIG. 2 shows a schematic representation of an electrical flat socket contact device 100 according to one embodiment.

The embodiment in FIG. 2 is based on the embodiment in FIG. 1 and comprises a large part of the features described there.

FIG. 2 shows the design of the inner and outer partial walls 115, 117 of the top wall 111. The inner and outer partial walls 115, 117 are arranged here to lie flat on top of each other. The inner partial wall 115 describes an inner ceiling boundary of the contact box unit 103. The already mentioned at least one spring element unit 113 is formed on the inner partial wall 115. In the embodiment shown, the spring element unit 113 is designed as a bending element and extends into the receiving space of the contact box unit 103. In the embodiment shown, the spring element unit 113 has a 180° bend 169 and is integrally connected to the inner partial wall 115. The spring element unit 113 is arranged to extend at least partially along the inner partial wall 115 via the 180° bend 169. The spring element unit is arranged here to exert a contact normal force in the direction of the base wall 109 of the carrier structure 101.

In the embodiment shown, the 180° bend of a side edge of the inner partial wall 115 is formed and thus runs parallel to the second side wall element 123. The side edge of the inner partial wall 115 is aligned parallel to the second side wall element 123. The spring element unit 113 thus extends perpendicular to the longitudinal axis L of the contact box unit 103. The spring element unit 113, which is formed as a bending element 125, comprises a first end 114 and an oppositely arranged second end 116. The first end is connected to the 180° bend, while the second end 116 is formed as a free end. Between the first and second ends 114, 116, two bar elements 118, 122 are formed which are connected to each other via a bend 120. The two inclined bar elements 118, 122 of the spring element unit 113 are at an angle to each other due to the bend 120. The second end 116 is also in contact with the inner partial wall 115. As a result, the two bar elements 118, 122 and the bend 120 are spaced apart from the inner partial wall 115 and protrude into the receiving space of the contact box unit 103.

In the embodiment shown, in addition to the clinch connections 137 formed at the rear end 141, the contact body 107 is additionally fixed to the carrier structure 101 and in particular in the contact box unit 103 via a further clinch connection 137 formed at the front end 139. For this purpose, the contact body 107 has a further receiving recess 145 at the front end 139, into which the clinch connection 137 of the carrier structure 101 can engage. For this purpose, the clinch connection 137 is connected integrally to the base wall 109 of the carrier structure 101. The clinch connection 137 shown also has a curved region 163, which extends from the surface 165 of the contact body 107 into the contact box unit 103.

In the embodiment shown, the contact body 107 has the aforementioned plurality of contacting domes 133. The contacting domes 133 are again primarily cylindrical in shape and protrude from the surface 165 of the contact body 107. The contacting domes 133 are formed in groups spaced apart from one another over the surface 165 of the contact body 107.

In the embodiment shown, the carrier structure 101 also has a rear wall 147 at the rear end 141. The rear wall 147 is connected to the base wall 109 and is arranged at an angle to the latter. The contact box unit 103 is delimited towards the rear end 141 by the rear wall 147.

In the embodiment shown, the inner and outer partial walls 115, 117 are furthermore fixed into one another by two clinch connections 129. In the embodiment shown, the clinch connections 129 are formed integrally on the outer partial wall 117 at the front end 139 and engage around the inner partial wall 115.

In the embodiment shown, the first side wall element 121 is largely formed as a continuous wall element. The second side wall element 123, on the other hand, is formed by two bar elements 173, which are arranged one at the front end 139 and one at the rear end 141.

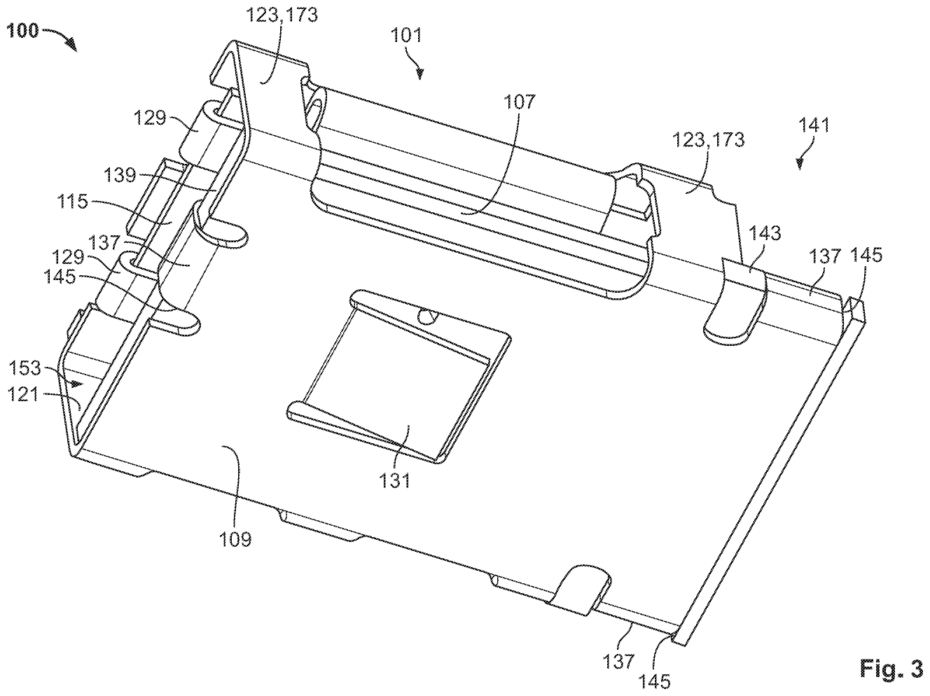

FIG. 3 shows a further schematic representation of an electrical flat socket contact device 100 according to a further embodiment.

FIG. 3 is based on the embodiment in FIG. 2 and comprises all the features described there.

In the embodiment shown, a further fixing catch 131 is formed on the base wall 109 of the carrier structure 101. The further fixing catch 131 again enables the flat socket contact device 100 to be fixed to a corresponding receptacle.

The fixing catches 131 on the base wall 109 and on the outer partial wall 117 are each formed by a punching and bending process from the respective walls 109, 117 and protrude from these.

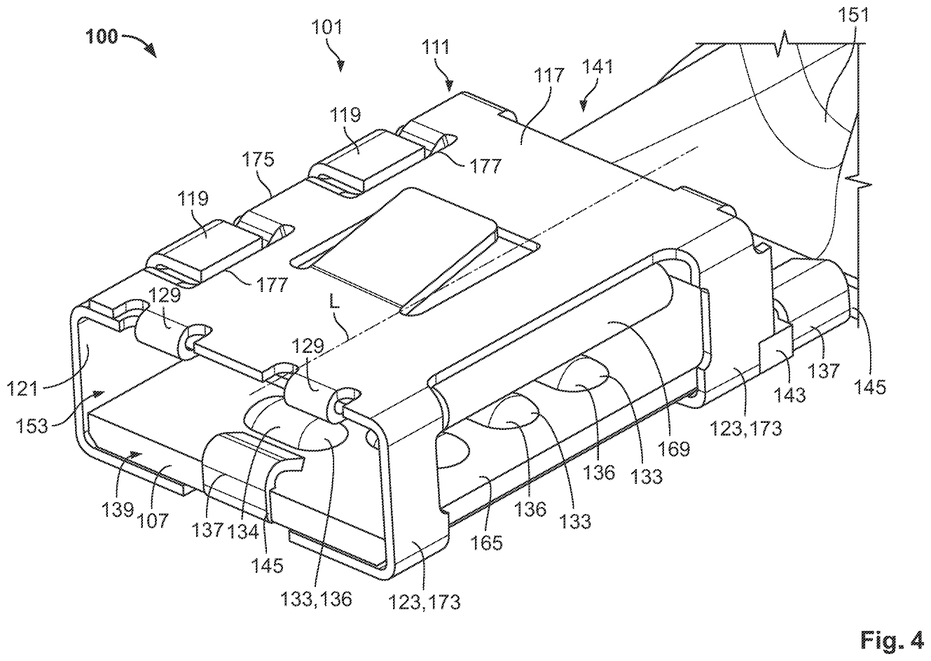

FIG. 4 shows a further schematic representation of an electrical flat socket contact device 100 according to a further embodiment.

The embodiment shown is based on the embodiment in FIG. 2 and comprises all the features described there.

In the embodiment shown, the inner and outer partial walls 115, 117 are fixed together by two further clinch connections 129 in addition to the clinch connections 129 formed at the front end 139. The further clinch connections 129 are formed here on a side region 175 of the carrier structure 101. The clinch connections 129 are formed integrally on the first side wall element 121. The outer partial wall 117 has two receiving recesses 177 for receiving the side clinch connections 129, said recesses being arranged on the side region 175 of the outer partial wall 117.

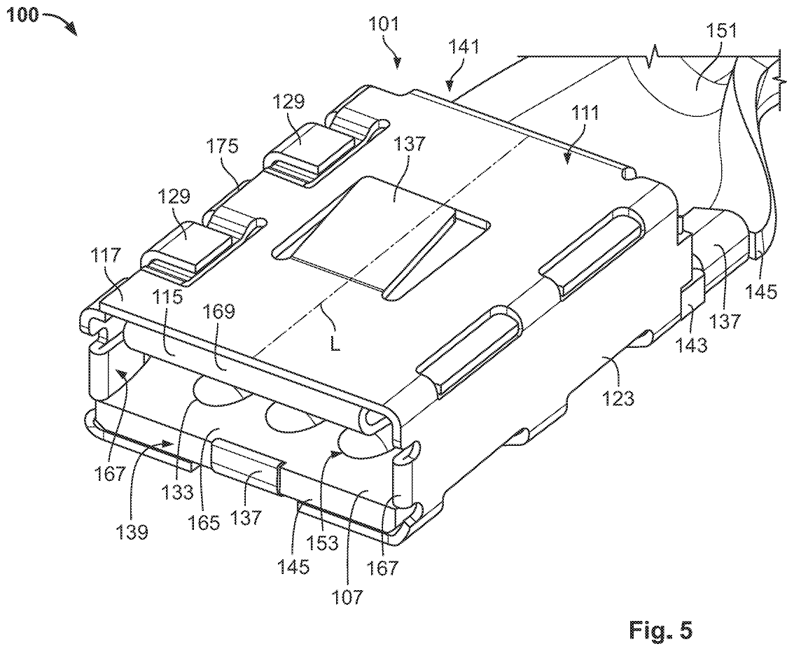

FIG. 5 shows a further schematic representation of an electrical flat socket contact device 100 according to a further embodiment.

The embodiment shown in FIG. 5 is based on the embodiment in FIG. 4 and comprises all the features described there. The embodiment shown differs from the embodiment in FIG. 4 in that the second side wall element 123 is designed as a continuous wall element and is not formed by the two bar elements 173 as in the embodiment in FIG. 4.

Furthermore, the clinch connection 137 formed at the front end 139 for fixing the contact body 107 is formed without the curved region 163. The clinch connection 137, on the other hand, is flush with the surface 165 of the contact body 107.

In addition, the first and second side wall elements 121, 123 have the side fold-over elements 167 already shown in FIG. 1.

In addition, the outer partial wall 117 has no clinch connections 129 at the front end 139. The inner and outer partial walls 115, 117 are thus fixed to one another exclusively via the clinch connections 129 formed on the side region 175.

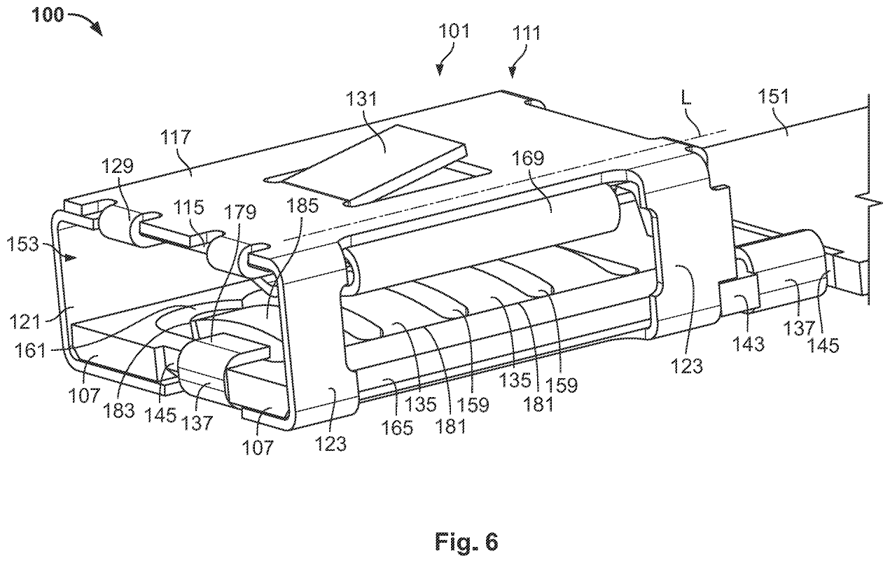

FIG. 6 shows a further schematic representation of an electrical flat socket contact device 100 according to a further embodiment.

The embodiment in FIG. 6 is based on the embodiment in FIG. 4. In contrast to the embodiment in FIG. 4, no further clinch connections 129 are formed on the side region 175. In addition, the clinch connection 137 formed at the front end 139 does not have a curved region 163. The clinch connection 137 has a contact region 179 that rests directly on the surface 165 of the contact body 107. Furthermore, the contacting domes 133 of the contact body 107 are replaced by contacting springs 135. The contacting springs 135 run perpendicular to the longitudinal direction L of the carrier structure 101. The longitudinal direction L runs here from the front end 139 to the rear end 141.

The plurality of contacting springs 135 are separated by slotted recesses 159, which are also arranged perpendicular to the longitudinal direction L.

The contacting springs 135 each have a first end 181 and an oppositely arranged second end 183. The first end 181 is formed integrally on the contact body 107, while the second end 183 is formed as a free end. The contacting springs 135 also have a curved region 185. The curved region 185 extends between the first and second ends 181, 183 and extends into the receiving space of the contact box unit 103.

The second ends 183 of the contacting springs 135 are freely mounted in round recesses 161, so that the second end 183 is freely movable relative to the contact body 107 and the contacting springs are set up to provide a contact normal force via the curved region 183.

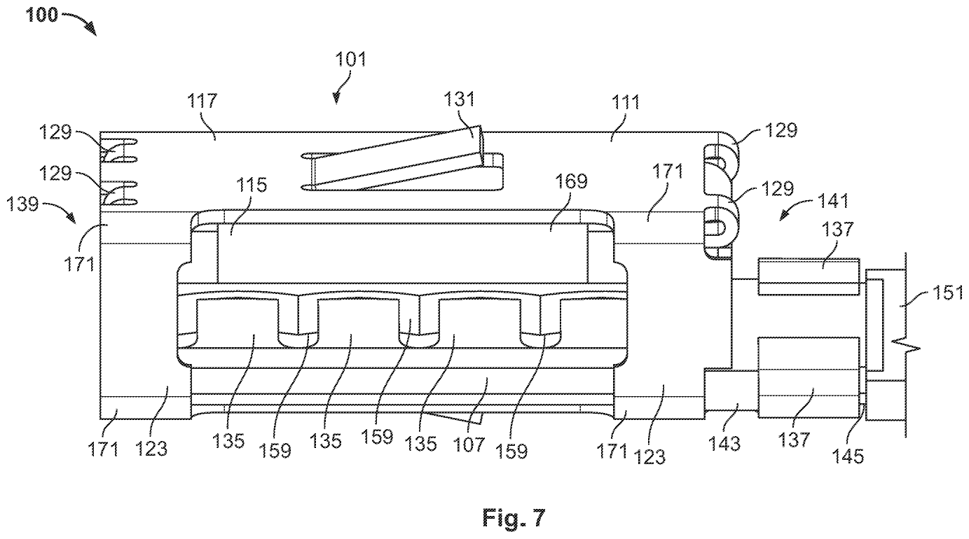

FIG. 7 shows a further schematic representation of an electrical flat socket contact device 100 according to a further embodiment.

The embodiment shown is based on the embodiment in FIG. 6 and comprises all the features described there. FIG. 7 primarily shows a side view of the flat socket contact device 100 in FIG. 6. In FIG. 7, the contacting springs 135 are shown aligned parallel to each other and perpendicular to the longitudinal direction L. The contacting springs 135 are separated from each other by the slotted recesses 177 and the second ends 183 are freely movable in the round recesses 161.

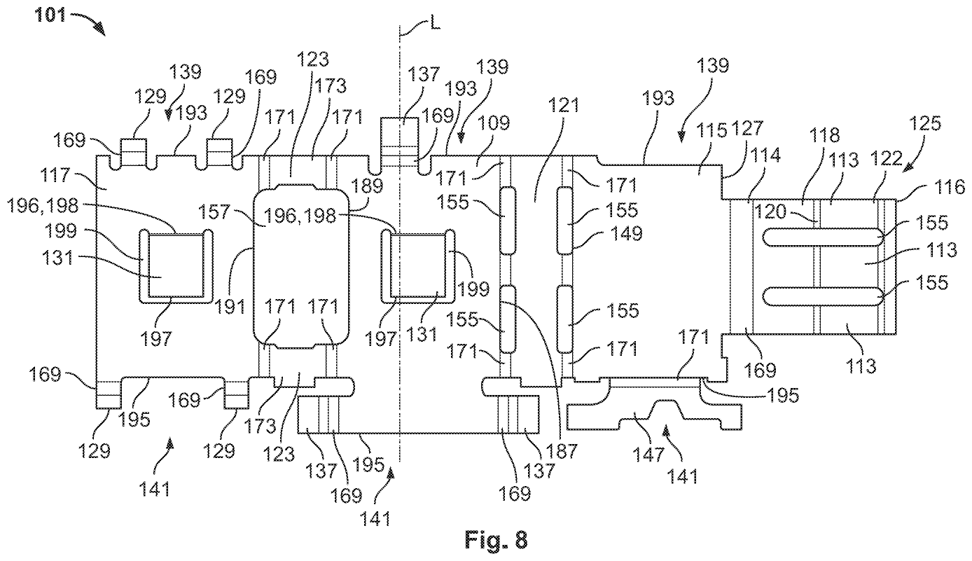

FIG. 8 shows a further schematic representation of an electrical flat socket contact device 100 according to a further embodiment.

In the embodiment shown, the carrier structure 101 of the flat socket contact device 100 is designed as a coherent bending structure. The individual components of the carrier structure 101, i.e. the base wall 109, the inner and outer partial walls 115, 117, and the first and second side wall elements 121, 123 are integrally connected to one another in the embodiment shown.

The base wall 109 is connected here to the first side wall element 121 at a third side edge 187 and to the second side wall element 123 via a fourth side edge 189. The outer partial wall 117 is also connected to the second side wall element 123 via a fifth side edge 191. The inner partial wall 115 is connected to the first side wall element 121 via a second side edge 149. Furthermore, the spring element unit 113 is formed on a first side edge 127 of the inner partial wall 115.

At the connections to said side edges, the first and second side wall elements 121, 123 have 90° bends 171. In the illustration shown, the carrier structure 101 is shown in an unbent form and describes a flat structure. The three-dimensional, primarily cuboid carrier structure 101 of FIGS. 1 to 7 is produced by corresponding bending processes at the 90° bends 171 and 180° bends 169.

Furthermore, the outer partial wall 117 has the two clinch connections 129 spaced apart from one another at a front edge 193. Similarly, the outer partial wall 117 has two clinch connections 129 at the rear edge 195.

Similarly, the base plate 109 has a further clinch connection 137 at a front edge 193 and two laterally arranged clinch connections 137 at a rear edge 195.

The clinch connections 129, 137 each have 180° bends 169, by means of which the clinch connections 129 can be bent around the inner partial wall 115 and the clinch connections 137 can be bent around the contact body 107.

The inner partial plate 115 also has the rear wall 147 at a rear edge 195. The rear wall 147 is in turn arranged on the inner partial plate 115 via a 90° bend 171 and can thus be bent through 90° in order to provide the rearward delimitation of the contact box unit 103.

In the embodiment shown, the contacting spring 135 is arranged on the first side edge 127 via the 180° bend 169. In the embodiment shown, the spring element unit is designed as a bending element 125 and has three spring element units 113 arranged next to one another, which are each separated from one another by slots 155. The bending element 125 has a first end 114 and an oppositely arranged second end 116. The bending element 125 is connected to the 180° bend 169 via the first end 114, while the second end 116 is formed as a free end. The individual spring element units 113 have two bar elements 118, 122, which are connected to one another via a bend 120. The bar elements 118, 122 can be arranged at an angle to one another via the bend 120. Via the bend 120 and the bar elements 118, 122, such as the 180° bend 169, the spring element units 113 are able to effect a corresponding contact normal force. The 180° bend 169 allows the spring element units 113 or the bending element 125 to be arranged at least partially parallel to the inner partial wall 115, since the spring element units 113 are arranged perpendicular to the longitudinal direction L of the contact box unit and extend along the inner partial wall 115, as shown in the embodiments of FIGS. 2 to 4 and 6 and 7. The second ends 116 can make contact here with the inner partial wall 115, while the bar elements 118, 122 connected to one another by the bend 120 are spaced apart from the inner partial wall 115 and extend into the receiving space of the contact box unit 103, in order to ensure the return

Similarly, the spring element units 113 or the spring element units 113 of the bending element 125 can also be formed at the front edge 193 of the inner partial wall 115 via a corresponding 180° bend 169, as shown in the embodiments of FIGS. 1 and 5. In such a configuration, the spring element units 113 of the bending element 125 run parallel to the longitudinal axis L of the contact box unit 103.

In the embodiment shown, the first side wall element 121 has four slots 155, which are arranged in the region of the 90° bends 171. Similarly, the second side wall element 123 has a recess 157 and is primarily formed by the bar elements 173.

Furthermore, the base wall 109 and the outer partial wall 117 have the fixing catches 131. The fixing catches 131 each have a first end 196 and an opposite second end 197. The first end 196 is connected to the base wall 109 or the outer partial wall 117 via a bend 198. The second end 197, on the other hand, is formed as a free end. Via the bend 198, the fixing catch 131 can be bent relative to the base wall 109 or the outer partial wall 117 at an angle that can be set as desired. This allows the fixing catch 137 to generate a contact normal force. The fixing catch 137 is manufactured by a stamping process and is surrounded by a primarily U-shaped slot 199.

According to one embodiment, the carrier structure 101 is made of stainless steel. The carrier structure 101 can be manufactured from a corresponding sheet material by a stamping process and transformed into the three-dimensional carrier structure 101 of FIGS. 1 to 7 by the bending processes described above at the bends 169, 171, 198 provided for this purpose.

The embodiment shown in FIG. 8 is primarily merely exemplary and may deviate from the embodiment shown in respect of various factors. In particular, the spring element units 113 may differ in shape, number and orientation from the embodiment shown.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Electrical flat socket contact device for an electrical power connection comprising:
a carrier structure, wherein the carrier structure forms a primarily cuboid contact box unit, into which a primarily cuboid tab contact for electrically contacting the flat socket contact device can be plugged; and
a primarily cuboid contact body arranged in the contact box unit for contacting the tab contact plugged into the contact box unit,
wherein the contact body is arranged on a base wall of the carrier structure, wherein on a top wall of the carrier structure arranged opposite the base wall there is arranged at least one spring element unit for mechanically contacting the tab contact, and wherein the top wall has a greater wall thickness than the base wall.

2. Flat socket contact device according to claim 1, wherein the top wall comprises an inner partial wall and an outer partial wall, wherein the inner and outer partial walls are arranged to contact one another in a planar manner, wherein the inner partial wall defines an inner wall of the contact box unit, and wherein the at least one spring element unit is formed on the inner partial wall.

3. Flat socket contact device according to claim 2, wherein the base wall is integrally connected via a first side wall element to the inner partial wall and via a second side wall element to the outer partial wall, and wherein the first and second wall elements define side walls of the contact box unit.

4. Flat socket contact device according to claim 3, wherein the first and second side wall elements are each arranged at an angle to the base wall and to the inner and outer partial walls via 90° bends.

5. Flat socket contact device according to claim 2, wherein the at least one spring element unit is formed integrally on the inner partial wall.

6. Flat socket contact device according to claim 2, wherein the at least one spring element unit is designed as a bending element and is arranged on a side edge of the inner partial wall, and wherein the spring element unit extends at least partially along the inner partial wall via a 180° bend.

7. Flat socket contact device according to claim 2, wherein the inner partial wall and the outer partial wall are connected to one another via at least one clinch connection and/or a welded connection.

8. Flat socket contact device according to claim 2, wherein a fixing catch is arranged on the outer partial wall and/or on the base wall for fixing the flat socket contact device to a holding device.

9. Flat socket contact device according to claim 2, wherein the rear wall is formed integrally on a side edge of the inner partial wall, and wherein the rear wall is arranged at an angle to the inner partial wall via a 90° bend.

10. Flat socket contact device according to claim 1, wherein the carrier structure is designed as a multi-surface bending structure.

11. Flat socket contact device according to claim 1, wherein at least one contacting dome and/or at least one contacting spring is formed on the contact body for contacting the tab contact.

12. Flat socket contact device according to claim 1, wherein the contact body is connected via at least one clinch connection to the base wall of the carrier structure within the contact box unit.

13. Flat socket contact device according to claim 1, wherein at least one clinch connection is formed at a front end, via which the tab contact can be plugged into the contact box unit, and/or at a rear end of the contact box unit arranged opposite the front end.

14. Flat socket contact device according to claim 1, wherein the contact body, at a front end and/or at a side region of the contact body, comprises at least one receiving recess for receiving at least one clinch connection.

15. Flat socket contact device according to claim 1, wherein the contact box unit is delimited at a rear end via a rear wall of the carrier structure.

16. Flat socket contact device according to claim 1, wherein the carrier structure is manufactured from stainless steel or from a copper compound.

17. Flat socket contact device according to claim 1, wherein the carrier structure is configured via the at least one spring element unit to provide a contact normal force of up to 40 N, preferably 50 N, particularly preferably 60 N, for contacting the plugged-in tab contact.

18. Flat socket contact device according to claim 1, wherein the tab contact can be clamped in the contact box unit via the spring element unit.

19. Flat socket contact device according to claim 1, wherein the flat socket contact device is designed for electrical voltages of at least approximately: 200V, 300V, 400V, 500V, 1 kV, 1.25 kV or 1.5 kV and/or for electrical currents of at least approximately: 200 A, 300 A, 400 A, 500 A, 600 A, 800 A, 1 kA or 1.25 kV.

20. Electrical connection system comprising:
an electric flat socket contact device comprising a carrier structure and a primarily cuboid contact body, the carrier structure forms a primarily cuboid contact box unit, the primarily cuboid contact body arranged in the contact box unit, the contact body is arranged on a base wall of the carrier structure, wherein on a top wall of the carrier structure arranged opposite the base wall there is arranged at least one spring element unit, wherein the top wall has a greater wall thickness than the base wall; and
a primarily cuboid tab contact pluggable into the primarily cuboid contact box unit, the primarily cuboid tab contact engages the primarily cuboid contact body when the tab contact is plugged into the contact box unit, wherein the at least one spring element unit mechanically contacts the tab contact when the tab contact is plugged into the contact box unit.
